(19) United States
(12) Patent Application Publication
(10) Pub. No.: US 2007/0107029 A1
(43) Pub. Date: May 10, 2007

(54) Multiple Video Display Configurations & Bandwidth Conservation Scheme for Transmitting Video Over a Network

(75) Inventors: David A. Monroe, San Antonio, TX (US); John M. Baird, San Antonio, TX (US)

Correspondence Address: MOORE LANDREY, 1609 SHOAL CREEK BLVD, AUSTIN, TX, 78701, US

(73) Assignee: E-Watch Inc., San Antonio, TX (US)

(21) Appl. No.: 11/617,554

(22) Filed: Dec. 28, 2006

Related U.S. Application Data
(63) Continuation of application No. 09/715,783, filed on Nov. 17, 2000.

(51) Int. Cl. H04N 7/173

(52) U.S. Cl. 725/105

(57) ABSTRACT

A system for capturing, encoding and transmitting continuous video from a camera to a display monitor via a network includes a user friendly interface wherein a map is provided at a display screen for illustrating the location of the cameras and indicating the direction of the camera angle. The monitor includes a display area for selectively displaying selected cameras and for controlling the selection, display and direction of the cameras from a remote location. The display screen can be configured to display one or any combination of cameras. The cameras can be selected by manual selection, pre-programmed sequencing or by event detection with the selected camera automatically displayed on the display area. Secondary monitors may be incorporated to enhance the display features. The secondary monitors are controlled by the control panel provided on the primary monitor.

### BACKGROUND OF INVENTION

1. Field of Invention

The invention is generally related to digital video transmission systems and is specifically directed to a method and apparatus for compressing and distributing digitized video over a network for supporting the transmission of live, near real-time video data in a manner to maximize display options while conserving bandwidth requirements.

2. Description of the Prior Art

Cameras employ digital encoders that produce industry-standard digital video streams such as, by way of example, MPEG-1 streams. The use of MPEG-1 streams is advantageous due to the low cost of the encoder hardware, and to the ubiquity of software MPEG-1 players. However, difficulties arise from the fact that the MPEG-1 format was designed primarily to support playback of recorded video from a video CD, rather than to support streaming of ‘live’ sources such as surveillance cameras and the like.

MPEG system streams contain multiplexed elementary bit streams containing compressed video and audio. Since the retrieval of video and audio data from the storage medium (or network) tends to be temporally discontinuous, it is necessary to embed certain timing information in the respective video and audio elementary streams. In the MPEG-1 standard, these consist of Presentation Timestamps (PTS) and, optionally, Decoding Timestamps (DTS).

On desktop computers, it is common practice to play MPEG-1 video and audio using a commercially available software package, such as, by way of example, the Microsoft Windows Media Player. This software program may be run as a standalone application. Otherwise, components of the player may be embedded within other software applications. Media Player, like MPEG-1 itself, is inherently file-oriented and does not support playback of continuous sources such as cameras via a network. Before Media Player begins to play back a received video file, it must first be informed of certain parameters including file name and file length. This is incompatible with the concept of a continuous streaming source, which may not have a filename and which has no definable file length. Moreover, the time stamping mechanism used by Media Player is fundamentally incompatible with the time stamping scheme standardized by the MPEG-1 standard. MPEG-1 calls out a time stamping mechanism which is based on a continuously incrementing 94 kHz clock located within the encoder. Further, the MPEG-1 standard assumes no Beginning-of-File marker, since it is intended to produce a continuous stream.

Media Player, on the other hand, accomplishes time stamping by counting 100's of nanoseconds since the beginning of the current file.

### SUMMARY OF INVENTION

The subject invention is directed to a streaming video system for capturing, encoding and transmitting continuous video from a camera to a display monitor via a network includes an encoder for receiving a video signal from the camera, the encoder producing a high-resolution output signal and a low-resolution output signal representing the video signal, a router or switch for receiving both the high-resolution output signal and the low-resolution output signal and a display monitor in communication with the router for selectively displaying either the high-resolution output signal or the low-resolution output signal. It will be understood by those skilled in the art that the terms “router and/or switch” as used herein is intended as a generic term for receiving and rerouting a plurality of signals. Hubs, switched hubs and intelligent routers are all included in the terms “router and/or switch” as used herein.

The system supports a plurality of cameras and an encoder associated with each of the cameras, the high-resolution output signal and low-resolution output signal unique to each camera being transmitted to the router. A management system is associated with each display monitor whereby each of the plurality of display monitors is adapted for displaying any combination of camera signals independently of the other of said plurality of display monitors.

The system of includes a selector for selecting between the high-resolution output signal and the low-resolution output signal based on the dimensional size of the display. The selector may be adapted for manually selecting between the high-resolution output signal and the low-resolution output signal. Alternatively, a control device may be employed for automatically selecting between the high-resolution output signal and the low-resolution output signal based on the size of the display. In one aspect of the invention, the control device may be adapted to assign a priority to an event captured at a camera and selecting between the high-resolution output signal and the low-resolution output signal based on the priority of the event.

It is contemplated that the system will be used with a plurality of cameras and an encoder associated with each of said cameras. The high-resolution output signal and low-resolution output signal unique to each camera is then transmitted to a router or switch, wherein the display monitor is adapted for displaying any combination of camera signals. In such an application, each displayed signal at a display monitor is selected between the high-resolution signal and the low-resolution signal of each camera dependent upon the number of cameras signals simultaneously displayed at the display monitor or upon the control criteria mentioned above.

The video system of the subject invention is adapted for supporting the use of a local-area-network (LAN) or wide-area-network (WAN), or a combination thereof, for distributing digitized camera video on a real-time or “near” real-time basis. In the preferred embodiment of the invention, the system uses a plurality of video cameras, disposed around a facility to view scenes of interest. Each camera captures the desired scene, digitizes (and encodes) the resulting video signal, compresses the digitized video signal, and sends the resulting compressed digital video stream to a multicast address. One or more display stations may thereupon view the captured video via the intervening network. Streaming video produced by the various encoders is transported over a generic IP network to one or more users. User workstations contain one or more ordinary PC's, each with an associated video monitor. The user interface is provided by an HTML application within an industry-standard browser, for example Microsoft Internet Explorer.

The subject invention comprises an intuitive and user-friendly method for selecting cameras to view. The main user interface screen provides the user with a map of the facility, which is overlaid with camera-shaped icons depicting location and direction of the various cameras and encoders. This main user interface has, additionally, a section of the screen dedicated to displaying video from the selected cameras.

The video display area of the main user interface may be arranged to display a single video image, or may be subdivided by the user into arrays of 4, 9, or 16 smaller video display areas.

Selection of cameras, and arrangement of the display area, is controlled by a mouse and conventional Windows user-interface conventions. Users may:

Select the number of video images to be displayed within the video display area. This is done by pointing and clicking on icons representing screens with the desired number of images.

Display a desired camera within a desired ‘pane’ in the video display area. This is done by pointing to the desired area on the map, then ‘dragging’ the camera icon to the desired pane.

Edit various operating parameters of the encoders. This is done by pointing to the desired camera, the right-clicking the mouse. The user interface then drops a dynamically-generated menu list which allows the user to adjust the desired encoder parameters.

It is often the case that the user may wish to observe more than 16 cameras, as heretofore discussed. To support this, the system allows the use of additional PC's and monitors. The additional PC's and monitors operate under the control of the main user application. These secondary screens do not have the facility map as does the main user interface. Instead, these secondary screens use the entire screen area to display selected camera video.

These secondary screens would ordinarily be controlled with their own keyboard and mouse interface systems. Since it is undesirable to clutter the user's workspace with multiple input interface systems, these secondary PC's and monitors operate entirely under the control of the main user interface. To support this, a series of button icons are displayed on the main user interface, labeled, for example, PRIMARY, 2,3, and 4. The video display area of the primary monitor then displays the video that will be displayed on the selected monitor. The primary PC, then, may control the displays on the secondary monitors. For example, a user may click on the ‘2’ button, which then causes the primary PC to control monitor number two. When this is done, the primary PC's video display area also represents what will be displayed on monitor number two. The user may then select any desired camera from the map, and drag it to a selected pane in the video display area. When this is done, the selected camera video will appear in the selected pane on screen number 2.

Streaming video signals tend to be bandwidth-intensive. Furthermore, since each monitor is capable of displaying up to 16 separate video images, the bandwidth requirements of the system can potentially be enormous. It is thus desirable to minimize the bandwidth requirements of the system.

To address this, each encoder is equipped with at least two MPEG-1 encoders. When the encoder is initialized, these two encoders are programmed to encode the same camera source into two distinct streams: one low-resolution low-bit rate stream, and one higher-resolution, higher-bit rate stream.

When the user has configured the video display area to display a single image, that image is obtained from the desired encoder using the higher-resolution, higher-bit rate stream. The same is true when the user subdivides the video display area into a 2×2 array; the selected images are obtained from the high-resolution, high-bit rate streams from the selected encoders. The network bandwidth requirements for the 2×2 display array are four times the bandwidth requirements for the single image, but this is still an acceptably small usage of the network bandwidth.

However, when the user subdivides a video display area into a 3×3 array, the demand on network bandwidth is 9 times higher than in the single-display example. And when the user subdivides the video display area into a 4×4 array, the network bandwidth requirement is 16 times that of a single display. To prevent network congestion, video images in a 3×3 or 4×4 array are obtained from the low-resolution, low-speed stream of the desired encoder. Ultimately, no image resolution is lost in these cases, since the actual displayed video size decreases as the screen if subdivided. That is, if a higher-resolution image were sent by the encoder, the image would be decimated anyway in order to fit it within the available screen area. It is, therefore, an object and feature of the subject invention to provide the means and method for displaying “live” streaming video over a commercially available media player system. It is a further object and feature of the subject invention to provide the means and method for permitting multiple users to access and view the live streaming video at different time, while in process without interrupting the transmission.

It is a further object and feature of the subject invention to permit conservation of bandwidth by incorporating a multiple resolution scheme permitting resolution to be selected dependent upon image size and use of still versus streaming images.

Other objects and feature of the subject invention will be readily apparent from the accompanying drawings and detailed description of the preferred embodiment.

### BRIEF DESCRIPTION OF THE DRAWINGS

FIG. 1 is a block diagram of a typical multi-camera system in accordance with the subject invention.

FIG. 2 is an illustration of the scheme for multicast address resolution.

FIG. 3 illustrates a typical screen layout.

FIG. 4 is an illustration of the use of the bandwidth conservation scheme of the subject invention.

### DESCRIPTION OF THE PREFERRED EMBODIMENT

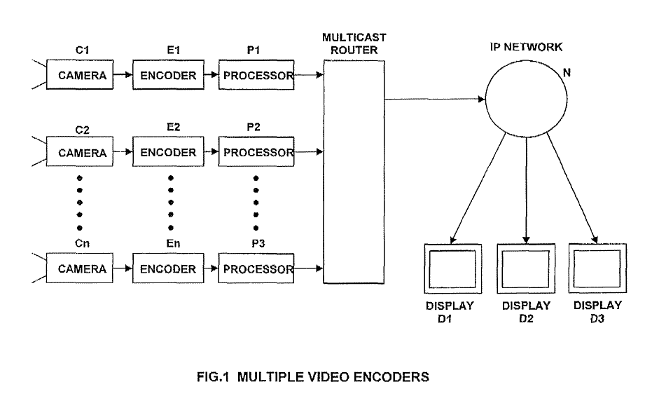

The video surveillance system of the subject invention is specifically adapted for distributing digitized camera video on a real-time or near real-time basis over a LAN and/or a WAN. As shown in FIG. 1, the system uses a plurality of video cameras C1, C2 . . . Cn, disposed around a facility to view scenes of interest. Each camera captures the desired scene, digitizes the resulting video signal at a dedicated encoder module E1, E2 . . . En, respectively, compresses the digitized video signal at the respective compressor P1, P2 . . . Pn, and sends the resulting compressed digital video stream to a multicast address router R. One or more display stations D1, D2 . . . Dn may thereupon view the captured video via the intervening network N. The network may be hardwired or wireless, or a combination, and may either a Local Area Network (LAN) or a Wide Area Network (WAN), or both.

The preferred digital encoders E1, E2 . . . En produce industry-standard MPEG-1 digital video streams. The use of MPEG-1 streams is advantageous due to the low cost of the encoder hardware, and to the ubiquity of software MPEG-1 players. However, difficulties arise from the fact that the MPEG-1 format was designed primarily to support playback of recorded video from a video CD, rather than to support streaming of ‘live’ sources such as cameras. MPEG-1 system streams contain multiplexed elementary bit streams containing compressed video and audio. Since the retrieval of video and audio data from the storage medium (or network) tends to be temporally discontinuous, it is necessary to embed certain timing information in the respective video and audio elementary streams. In the MPEG-1 standard, these consist of Presentation Timestamps (PTS) and, optionally, Decoding Timestamps (DTS). On desktop computers, it is common practice to play MPEG-1 video and audio using a proprietary software package such as, by way of example, the Microsoft Windows Media Player. This software program may be run as a standalone application, otherwise components of the player may be embedded within other software applications.

Media Player, like MPEG-1 itself, is inherently file-oriented and does support playback of continuous sources such as cameras via a network. Before Media Player begins to play back a received video file, it must first be informed of certain parameters including file name and file length. This is incompatible with the concept of a continuous streaming source, which may not have a filename and which has no definable file length.

Moreover, the time stamping mechanism used by Media Player is fundamentally incompatible with the time stamping scheme standardized by the MPEG-1 standard. MPEG-1 calls out a time stamping mechanism which is based on a continuously incrementing 94 kHz clock located within the encoder. Moreover, the MPEG-1 standard assumes no Beginning-of-File marker, since it is intended to produce a continuous stream. In the present invention, a common MPEG-1 encoder IC is used to perform the actual MPEG compression of a digitized camera signal. The IC selected is a W99200F IC, produced by Winbond Corporation of Taiwan. This IC produces an MPEG Video Elementary Stream that contains the appropriate PTS information as mandated by the MPEG standard.

When invoking Media Player to view the streaming camera video, it is first necessary to inform Media Player of the file length. Since the camera produces a stream rather than a discrete file, the file length is undefined. In order to overcome this problem all of the Media Player's 63-bit file length variables are set to 1. Media Player compares this value to a free-running counter that counts ticks of a 10 MHz clock. This counter is normally initialized to zero at the beginning of the file. Given 63 bits, this permits a maximum file length of approximately thirty thousand years, longer than the useful life of the product or, presumably, it's users. This effectively allows the system to play streaming sources.

The next problem arises when additional users attempt to connect to a stream that is already in progress. Media Player expects that file length and other related information is normally sent only once, in a file header, and is not periodically repeated. Thus, users connecting later will not receive the file length information contained in the header. The subject invention has overcome this problem by developing a software ‘front-end’ filter, which examines and modifies data being passed from the network to Media Player. This software formulates a dummy video file header, and passes it to Media Player. The filter then examines the incoming video stream, finds the next sequential Video Header, and thereupon begins passing the networked video data to the Media Player decoder and renderer. This effectively allows users to ‘tune in late’, by providing Media Player with an appropriate file header.

A further problem arises when the networked video data is passed to Media Player. Since the user has connected to the video stream after the start of the file, the first timestamp received by Media Player will be non-zero, which causes an error. To overcome this problem, the front-end software filter replaces each received timestamp with a value of (current timestamp minus first timestamp received), which effectively re-numbers the timestamp in the local video stream starting with an initial value of zero.

Any given source of encoded video may be viewed by more than one client. This could hypothetically be accomplished by sending each recipient a unique copy of the video stream. However, this approach is tremendously wasteful of network bandwidth. A superior approach is to transmit one copy of the stream to multiple recipients, via Multicast Routing. This approach is commonly used on the Internet, and is the subject of various Internet Standards (RFC's). In essence, a video source sends its' video stream to a Multicast Group Address, which exists as a port on a Multicast-Enabled network router or switch. The router or switch then forwards the stream only to IP addresses, which have known recipients. Furthermore, if the router or switch can determine that multiple recipients are located on one specific network path or path segment, the router or switch sends only one copy of the stream to that path.

From a client's point of view, the client need only connect to a particular Multicast Group Address to receive the stream. A range of IP addresses has been reserved for this purpose; essentially all IP addresses from 224.0.0.0 to 239.255.255.255 have been defined as Multicast Group Addresses.

Unfortunately, there is not currently a standardized mechanism to dynamically assign these Multicast Group Addresses, in a way that is known to be globally unique. This differs from the ordinary Class A, B, or C IP address classes. In these classes, a regulatory agency assigns groups of IP addresses to organizations upon request, and guarantees that these addresses are globally unique. Once assigned this group of IP addresses, a network administrator may allocate these addresses to individual hosts, either statically or dynamically DHCP or equivalent network protocols. This is not true of Multicast Group Addresses; they are not assigned by any centralized body and their usage is therefore not guaranteed to be globally unique.

Each encoder must possess two unique IP addresses—the unique Multicast Address used by the encoder to transmit the video stream, and the ordinary Class A, B, or C address used for more mundane purposes. It is thus necessary to provide a means to associate the two addresses, for any given encoder.

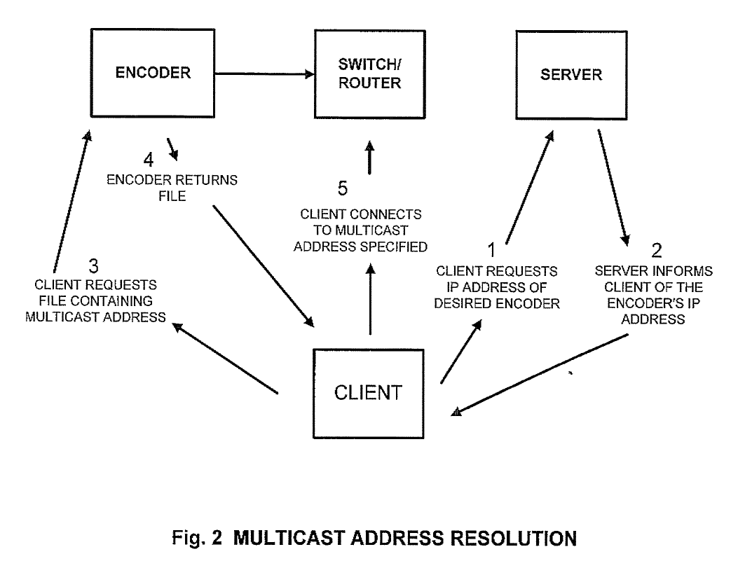

The subject invention includes a mechanism for associating the two addresses. This method establishes a sequential transaction between the requesting client and the desired encoder. An illustration of this technique is shown in FIG. 2.

First, the client requesting the video stream identifies the IP address of the desired encoder. This is normally done via graphical methods, described more fully below. Once the encoder's IP address is known, the client obtains a small file from an associated server, using FTP, TFTP or other appropriate file transfer protocol over TCP/IP. The file, as received by the requesting client, contains various operating parameters of the encoder including frame rate, UDP bit rate, image size, and most importantly, the Multicast Group Address associated with the encoder's IP address. The client then launches an instance of Media Player, initializes the previously described front end filter, and directs Media Player to receive the desired video stream from the defined Multicast Group Address.

Streaming video produced by the various encoders is transported over a generic IP network to one or more users. User workstations contain one or more ordinary PC's, each with an associated video monitor. The user interface is provided by an HTML application within an industry-standard browser, specifically Microsoft Internet Explorer.

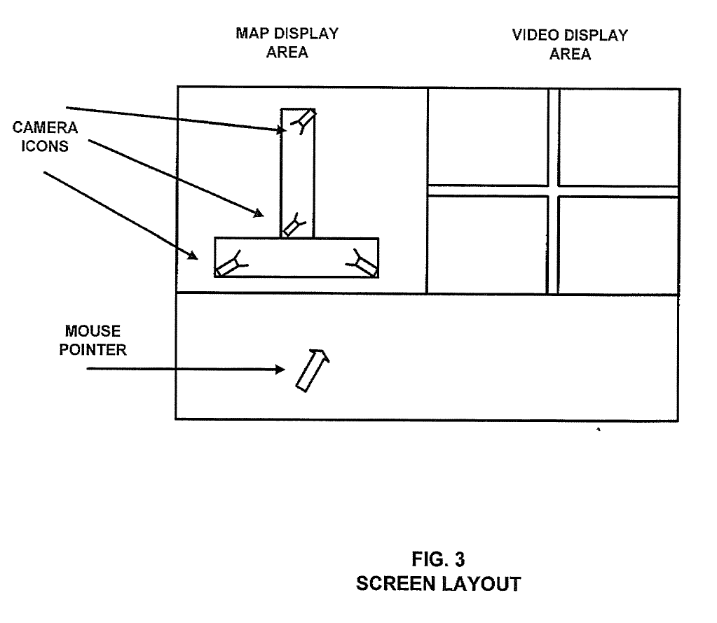

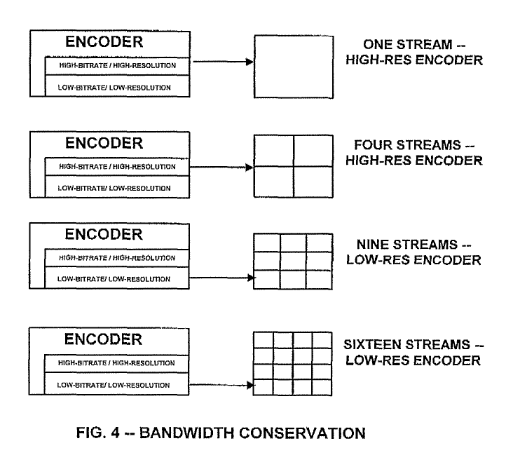

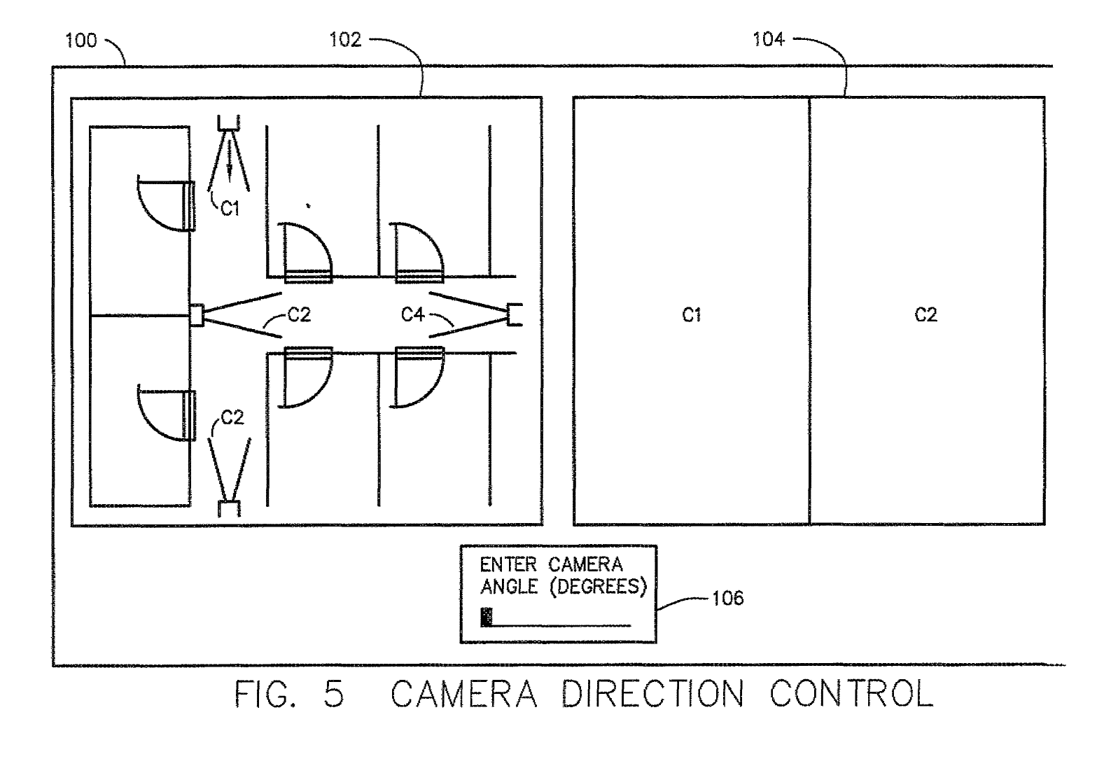

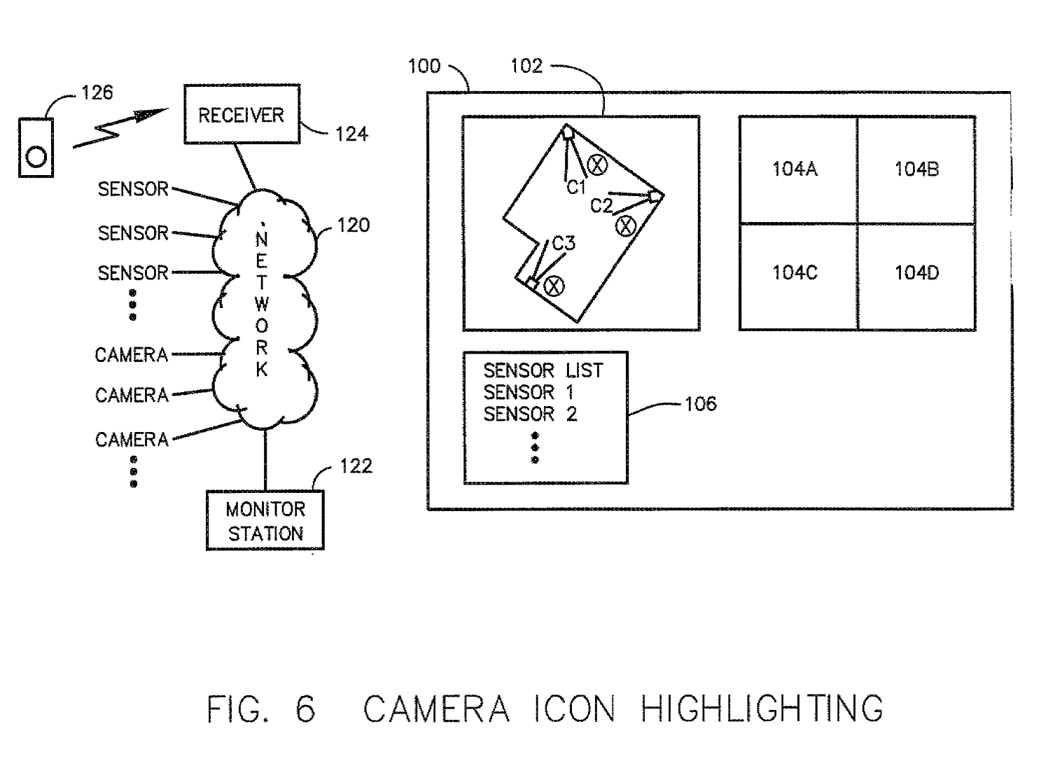

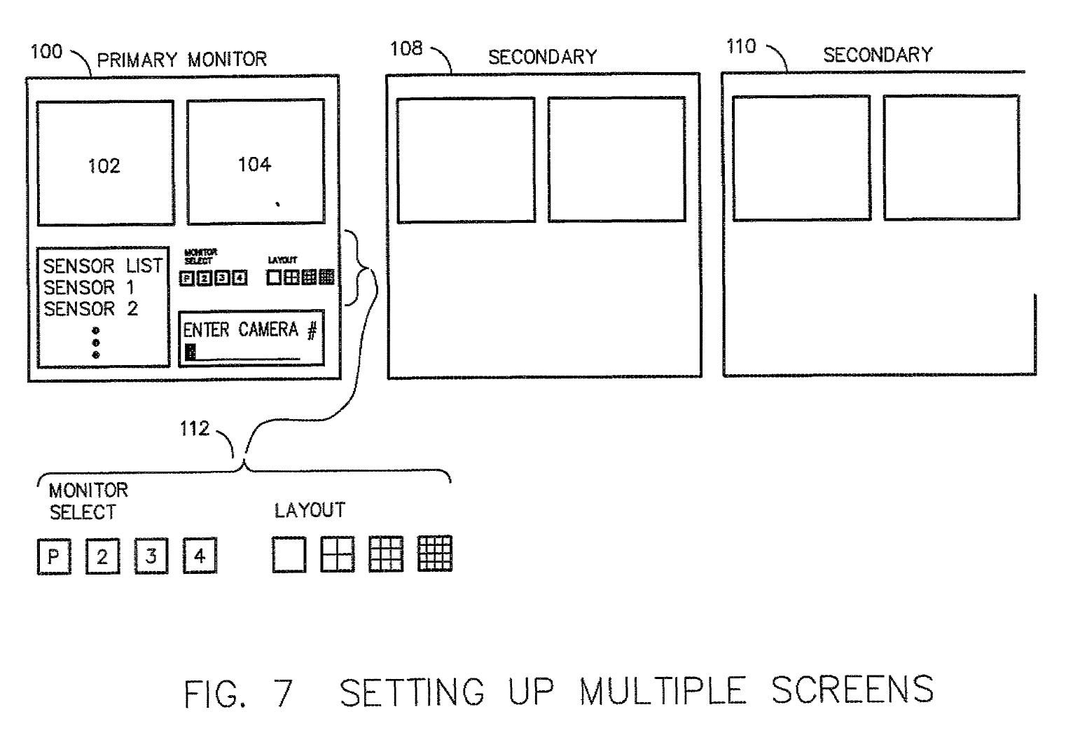

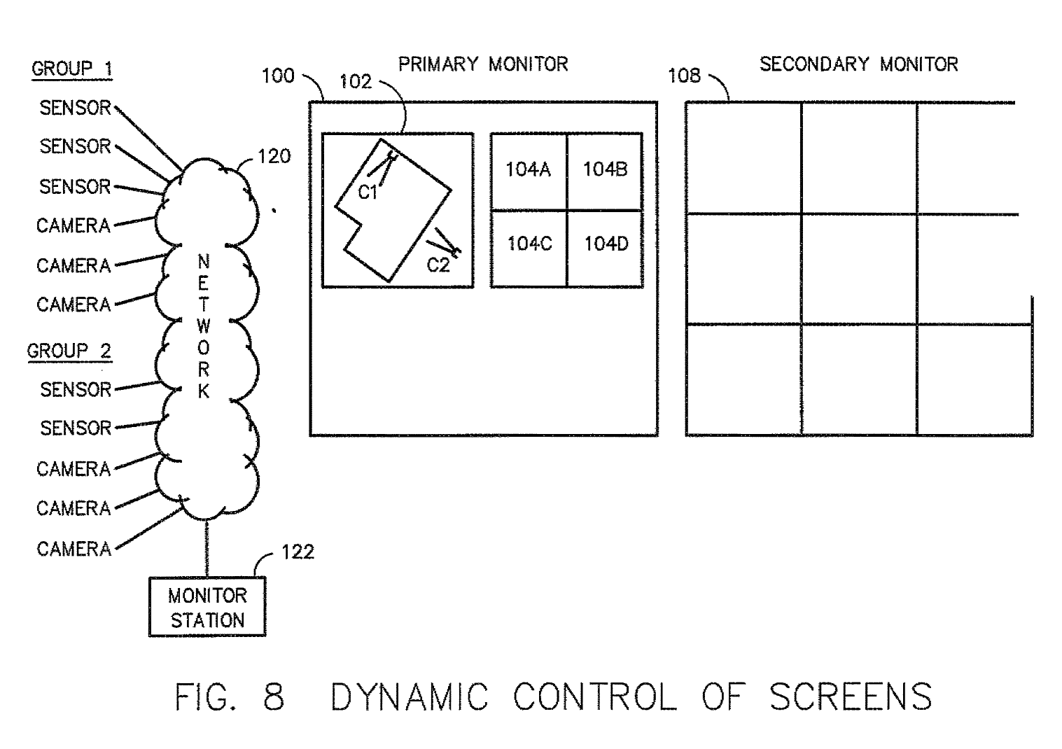

One aspect of the invention is the intuitive and user-friendly method for selecting cameras to view. The breadth of capability of this feature is shown in FIG. 3. The main user interface screen provides the user with a map of the facility, which is overlaid with camera-shaped icons depicting location and direction of the various cameras and encoders. This main user interface has, additionally, a section of the screen dedicated to displaying video from the selected cameras.

The video display area of the main user interface may be arranged to display a single video image, or may be subdivided by the user into arrays of 4, 9, or 16 smaller video display areas. Selection of cameras, and arrangement of the display area, is controlled by the user using a mouse and conventional Windows user-interface conventions. Users may:
Select the number of video images to be displayed within the video display area. This is done by pointing and clicking on icons representing screens with the desired number of images.
Display a desired camera within a desired ‘pane’ in the video display area. This is done by pointing to the desired area on the map, then ‘dragging’ the camera icon to the desired pane.
Edit various operating parameters of the encoders. This is done by pointing to the desired camera, the right-clicking the mouse. The user interface then drops a dynamically-generated menu list that allows the user to adjust the desired encoder parameters.

Some sample source is listed below:

```
// this function responds to a dragStart event on a camera
function cameraDragStart(i)
{
event.dataTransfer.setData(“text”,currSite.siteMaps[currSite.currMap].-
hotSpots[i].camera.id);
  dragSpot = currSite.siteMaps[currSite.currMap].hotSpots[i];
  event.dataTransfer.dropEffect = “copy”;
  dragging = true;
  event.cancelBubble = true;
}
// this function responds to a dragStart event on a cell
// we might be dragging a hotSpot or a zone
function cellDragStart(i)
{
  }
  }
// this function responds to a drop event on a cell input element
function drop(i)
{
```

| | |
|---|---|
| if (dragSpot != null) | // dragging a hotSpot |
| { | |
| } | |
| else if (dragZone != null) | // dragging a zone |
| object | |
| { | |
| currMonitor.zones[i] = dragZone; | // set the cell zone |

| | |
|---|---|
| dragZone = null; | // null |
| dragZone | |

| | |
|---|---|
| zoneVideo(currMonitor.id, i); | // start the video |
| } | |
| else | |
| { | |
| } | |
| else | |
| { | |
| dropCameraId(currMonitor,d,i); | // setup hotSpot |
| startMonitorVideo(currMonitor, i); | // start the video |

| | |
|---|---|
| displayCells( ); | // redisplay |
| the monitor cells | |
| } | |
| } | |
| dragging = false; | |

event.cancelBubble = true;
}

In the foregoing code, the function:
event. dataTransfer.setData (“text”,currSite.siteMaps[currSite.currMap].hotspots [i].camera.id)
retrieves the IP address of the encoder that the user has clicked. The subsequent function startMonitorVideo(currMonitor, i) passes the IP address of the selected encoder to an ActiveX control that then decodes and renders video from the selected source.

The system of includes a selector for selecting between the high-resolution output signal and the low-resolution output signal based on the dimensional size of the display. The selector may be adapted for manually selecting between the high-resolution output signal and the low-resolution output signal. Alternatively, a control device may be employed for automatically selecting between the high-resolution output signal and the low-resolution output signal based on the size of the display. In one aspect of the invention, the control device may be adapted to assign a priority to an event captured at a camera and selecting between the high-resolution output signal and the low-resolution output signal based on the priority of the event.

It is contemplated that the system will be used with a plurality of cameras and an encoder associated with each of said cameras. The high-resolution output signal and low-resolution output signal unique to each camera is then transmitted to a router or switch, wherein the display monitor is adapted for displaying any combination of camera signals. In such an application, each displayed signal at a display monitor is selected between the high-resolution signal and the low-resolution signal of each camera dependent upon the number of cameras signals simultaneously displayed at the display monitor or upon the control criteria mentioned above.

It is often the case that the user may wish to observe more than 16 cameras, as heretofore discussed. To support this, the system allows the use of additional PC's and monitors. The additional PC's and monitors operate under the control of the main user application. These secondary screens do not have the facility map as does the main user interface. Instead, these secondary screens use the entire screen area to display selected camera video.

These secondary screens would ordinarily be controlled with their own keyboards and mice. Since it is undesirable to clutter the user's workspace with multiple mice, these secondary PC's and monitors operate entirely under the control of the main user interface. To support this, a series of button icons are displayed on the main user interface, labeled, for example, PRIMARY, 2,3, and 4. The video display area of the primary monitor then displays the video that will be displayed on the selected monitor. The primary PC, then, may control the displays on the secondary monitors. For example, a user may click on the ‘2’ button, which then causes the primary PC to control monitor number two. When this is done, the primary PC's video display area also represents what will be displayed on monitor number two. The user may then select any desired camera from the map, and drag it to a selected pane in the video display area. When this is done, the selected camera video will appear in the selected pane on screen number 2.

Streaming video signals tend to be bandwidth-intensive. The subject invention provides a method for maximizing the use of available bandwidth by incorporating multiple resolution transmission and display capabilities. Since each monitor is capable of displaying up to 16 separate video images, the bandwidth requirements of the system can potentially be enormous. It is thus desirable to minimize the bandwidth requirements of the system.

To address this, each encoder is equipped with at least two MPEG-1 encoders. When the encoder is initialized, these two encoders are programmed to encode the same camera source into two distinct streams: one low-resolution low-bit rate stream, and one higher-resolution, higher-bit rate stream.

When the user has configured the video display area to display a single image, that image is obtained from the desired encoder using the higher-resolution, higher-bit rate stream. The same is true when the user subdivides the video display area into a 2×2 array; the selected images are obtained from the high-resolution, high-bit rate streams from the selected encoders. The network bandwidth requirements for the 2×2 display array are four times the bandwidth requirements for the single image, but this is still an acceptably small usage of the network bandwidth.

However, when the user subdivides a video display area into a 3×3 array, the demand on network bandwidth is 9 times higher than in the single-display example. And when the user subdivides the video display area into a 4×4 array, the network bandwidth requirement is 16× that of a single display. To prevent network congestion, video images in a 3×3 or 4×4 array are obtained from the low-resolution, low-speed stream of the desired encoder. Ultimately, no image resolution is lost in these cases, since the actual displayed video size decreases as the screen if subdivided. If a higher-resolution image were sent by the encoder, the image would be decimated anyway in order to fit it within the available screen area.

While specific features and embodiments of the invention have been described in detail herein, it will be understood that the invention includes all of the enhancements and modifications within the scope and spirit of the following claims.

1. A system for capturing, encoding and transmitting continuous video from a camera to a display monitor via a network, comprising:
a. An encoder for receiving a video signal from the camera, the encoder producing a high-resolution output signal and a low-resolution output signal representing the video signal;
b. A switching network for receiving both the high-resolution output signal and the low-resolution output signal;
c. A display monitor for in communication with the router for selectively displaying one of said high-resolution output signal and said low-resolution output signal.

2. The system of claim 1, wherein the switching network is a hub.

3. The system of claim 1, wherein the switching network is a switched hub.

4. The system of claim 1, wherein the switching network is a router.

5. The system of claim 1, further including a selector for selecting between the highresolution output signal and the low-resolution output signal based on the dimensional size of the display.

6. The system of claim 5, further including a selection device for manually selecting between the high-resolution output signal and the low-resolution output signal.

7. The system of claim 5, further including a control device for automatically selecting between the high-resolution output signal and the low-resolution output signal based on the size of the display.

8. The system of claim 5, further including a control device adapted for assigning a priority to an event captured at a camera and selecting between the high-resolution output signal and the low-resolution output signal based on the priority of the event.

9. The system of claim 5, wherein there is further included a plurality of cameras and an encoder associated with each of said cameras, the high-resolution output signal and low-resolution output signal unique to each camera being transmitted to the router, and wherein the display monitor is adapted for displaying any combination of camera signals.

10. The system of claim 5, wherein the displayed signal at the display monitor is selected between the high-resolution signal and the low-resolution signal of each camera dependent upon the number of cameras signals simultaneously displayed at the display monitor.

11. The system of claim 1, wherein there is further included a plurality of display monitors, each of which is in communication with the router, whereby each display monitor may selectively display the high-resolution signal and the low-resolution signal.

12. The system of claim 11, wherein there is further included a plurality of cameras and an encoder associated with each of said cameras, the high-resolution output signal and low-resolution output signal unique to each camera being transmitted to the router, and wherein there is further included a management system associated with each display monitor whereby each of the plurality of display monitors is adapted for displaying any combination of camera signals independently of the other of said plurality of display monitors.

13. The system of claim 1, wherein the display monitor includes a mapping feature illustrating the location of the camera.

14. The system of claim 1, wherein the output signal for the camera may be selected by activating the camera location on the mapping feature.

15. The system of claim 1, wherein the communications link between the router and the display monitor is a network.

16. The system of claim 15, wherein the network is hardwired.

17. The system of claim 15, wherein the network is wireless.

18. The system of claim 15, wherein the network is a wide area network.

19. The system of claim 15 wherein the network is a local area network.

20. The system of claim 1, wherein the communications link between the encoder and the router is a network.

21-38. (canceled)
